(19) United States
(12) Patent Application Publication
(10) Pub. No.: US 2014/0250631 A1
(43) Pub. Date: Sep. 11, 2014

(54) TUNED HINGE

(71) Applicant: GM GLOBAL TECHNOLOGY OPERATIONS LLC, Detroit, MI (US)

(72) Inventors: Todd E. Allen, Lake Orion, MI (US); Seung H. Lee, Troy, MI (US)

(73) Assignee: GM Global Technology Operations LLC, Detroit, MI (US)

(21) Appl. No.: 13/787,078

(22) Filed: Mar. 6, 2013

(51) Int. Cl. E05D 7/06

(52) U.S. Cl. CPC E05D 7/06
USPC 16/225; 29/11

(57) ABSTRACT

A product including a hinge which may include two opposed columns or towers defining at least one gap there between, and a compressible or elastomeric material filling at least a portion of the at least one gap.

### TECHNICAL FIELD

The field to which the disclosure relates generally to includes products including a hinge.

### BACKGROUND

A variety of products include a hinge.

### SUMMARY OF ILLUSTRATIVE VARIATIONS OF THE INVENTION

A number of variations may include a product comprising: a hinge which may include two opposed columns or towers defining at least one gap there between, and a compressible or elastomeric material filling at least a portion of the at least one gap. Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 illustrates a product including a front of the dash seal including a tuned hinge according to a number of variations of the invention.

FIG. 2 is a perspective view with portions removed illustrating a product including a front of dash seal including a tuned hinge.

FIG. 3 is a partial sectional view of a product including a front of dash seal including a tuned hinge according to a number of variations of the invention.

FIG. 4 is a sectional view of a product including a tuned hinge according to a number of variations of the invention.

FIG. 5 is a schematic illustration of insertion of a product including a flexible locking finger into an opening in a substrate according to a number of variations of the invention.

FIG. 6 is an illustration of a product including adjacent clip segment portions of which defining a hinge and showing the direction of forces applied to the hinge during insertion according to a number of variations of the invention.

FIG. 7 illustrates the extraction of a product including a flexible locking finger received in the opening of a substrate and showing forces applied to the hinge during extraction according to a number of variations of the invention.

FIG. 8 is an illustration of a product including adjacent clip segment portions of which defining a hinge and showing the direction of forces applied to the hinge during extraction according to a number of variations of the invention.

FIG. 9 is a perspective view of a product including an over mold portion having a plurality of ribs extending from a collar according to a number of variations of the invention.

FIG. 10 illustrates a product including a four segment tuned hinge clip assembly according to a number of variations of the invention.

FIG. 11 illustrates a product including a clip assembly being inserted into an opening in a substrate according to a number of variations of the invention.

FIG. 12 illustrates a product including a clip assembly bulging outward and holding the clip in position and opening in a substrate according to a number of variations of the invention.

FIG. 13 illustrates a product including a tuned hinge clip assembly with a compressible or elastomeric over mold according to a number of variations of the invention.

FIG. 14 illustrates a product including a clip assembly having four segments with each segment having a single flexible finger according to a number of variations of the invention.

FIG. 15 illustrates a product including a clip assembly having four segments, with each segment having two flexible locking fingers according to a number of variations of the invention.

FIG. 16 illustrates a product including a clip assembly having two segments, with each segment including four flexible locking fingers according to a number of variations of the invention.

FIG. 17 illustrates a product including a tuned hinge having a bridge connecting together adjacent segments according to a number of variations of the invention.

### DETAILED DESCRIPTION OF ILLUSTRATIVE VARIATIONS OF THE INVENTION

The following description of the variations is merely illustrative in nature and is in no way intended to limit the invention, its application, or uses.

A number of variations of the invention may include a product including a hinge which may include two opposed columns or towers defining at least one gap there between. A compressible or elastomeric material may fill at least a portion of the at least one gap. In a number of variations of the invention the two opposed columns or towers may define a second gap there between. The second gap may be void of any material therein, may be partially filled by a compressible or elastomeric material, or may be completely filled by a compressible or elastomeric material. The hinge may be tuned to require a desired force that is necessary to cause a lower portion of each of the two opposed columns or towers to be moved toward each other. The material of construction of the two opposed columns or towers and the compressible or elastomeric material as well as the dimensions the two opposed columns or towers and the at least one gap and/or a second gap may be selected to tune the force necessary to cause the lower portion of each of the two opposed columns or towers to be moved toward each other.

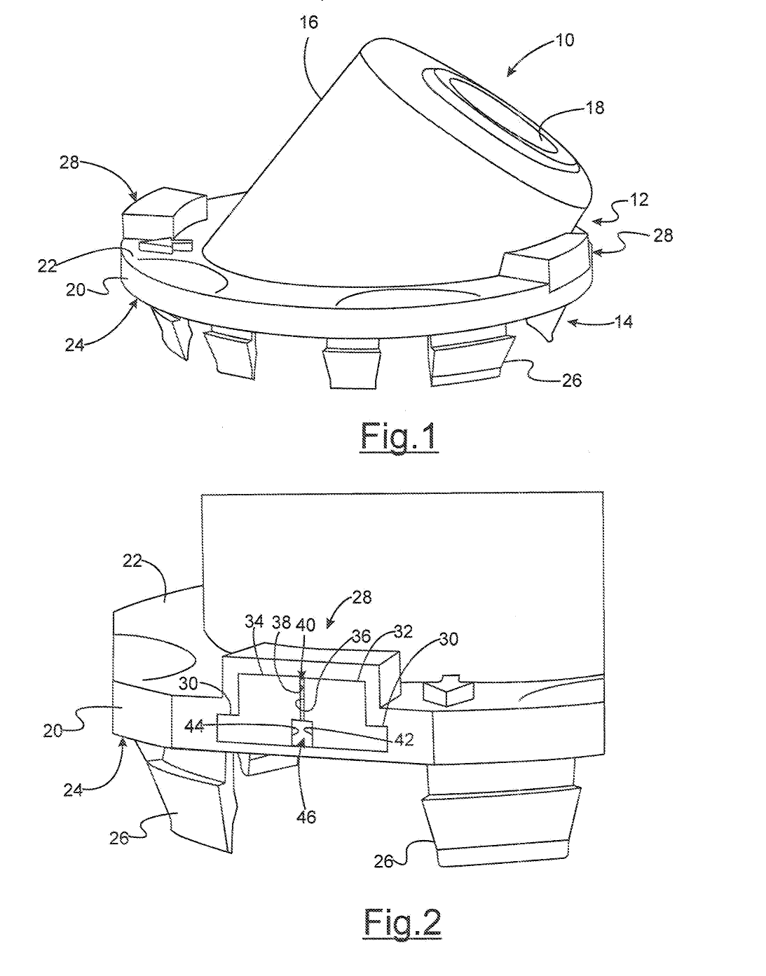

A number of variations of the invention are illustrated in FIG. 1 and may include a product 10, which may be a front of dash seal component for a vehicle. The product 10 may include a compressible or elastomeric material 12. The product 10 may include a clip assembly 14. In a number of variations the clip assembly 14 may be attached to the compressible or elastomeric material 12 for example, but not limited to, by an adhesive or by one or more mechanical fasteners. In a number of variations, the compressible or elastomeric material 12 may be molded over at least a portion of the clip assembly 14 to securely attach the same. In a number of variations the clip assembly 14 may include at least one flexible locking finger 26 constructed and arranged to be inserted into an opening in a substrate, such as but not limited to, a dashboard of a vehicle. In a number of variations, the product 10 may include a through hole 18 formed in the collar 16 constructed and arranged to receive a shaft of a steering wheel of the vehicle. In a number of variations, a flange 20 may extend outwardly from the collar 16 and may include an upper face 22 and a lower face 24. The product 10 may include a hinge 28, which may be constructed and arranged to facilitate insertion of the flexible locking fingers 26 into an opening in a substrate.

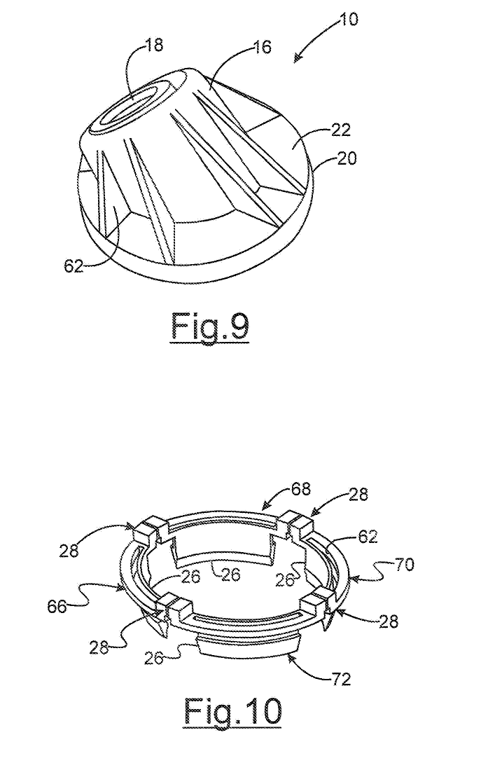

Referring now to FIG. 2, in a number of variations of the invention, the hinge 28 may include a first tower 32 and a second tower 34. The first tower 32 may have a first face 36 spaced from a second face 38 of the second tower 34 so that the first tower 32 and second tower 34 define at least a first gap 40 there between, which in a number of variations may be located between the first face 36 and the second face 38. In a number of variations the first tower 32 and second tower 34 may be separated and spaced apart from each other. The first tower 32 may connected to a first bridge deck 30 of a first segment 66 of a clip assembly 14. The first tower 32 may extend above the first bridge deck 30. The second tower 34 may be connected to a first bridge deck 30 of a second segment 68 (shown in FIGS. 10, 14-16) of the clip assembly 14. In a number of variations of the invention at least one flexible locking finger 26 may be attached to or extend from each of the first bridge deck 30 of first segment 66 and the first bridge deck 30 of the second segment 68.

In a number of variations, the first tower 32 may include a third face 42 positioned a distance horizontally from the first face 36. The second tower 34 may include a fourth face 44 positioned a distance horizontally from the second face 38 so that the first tower 32 and the second tower 34 defined a second gap 46 there between. In a number of variations the second gap 46 may be void of any material therein, may be partially filled with a compressive or elastomeric material, or may be completely filled with a compressive or elastomeric material. The first tower 32 and the second tower 34 may be constructed and arranged so that a lower portion 41 of the first tower 32 and a lower portion 43 of the second tower 34 may be moved toward each other.

FIG. 3 illustrates a product 10 including a mold over portion 12 that includes a collar 16 having a generally cone shape connected to a base portion 20′ which may have an annular shape. The hinge 28 may include a first gap 40 and a second 46 defined by the first tower 32 and second tower 34. As illustrated in FIG. 3, a number of variations of the invention may include a compressive or elastomeric material 12 which completely fills both the first gap 40 and the second gap 46.

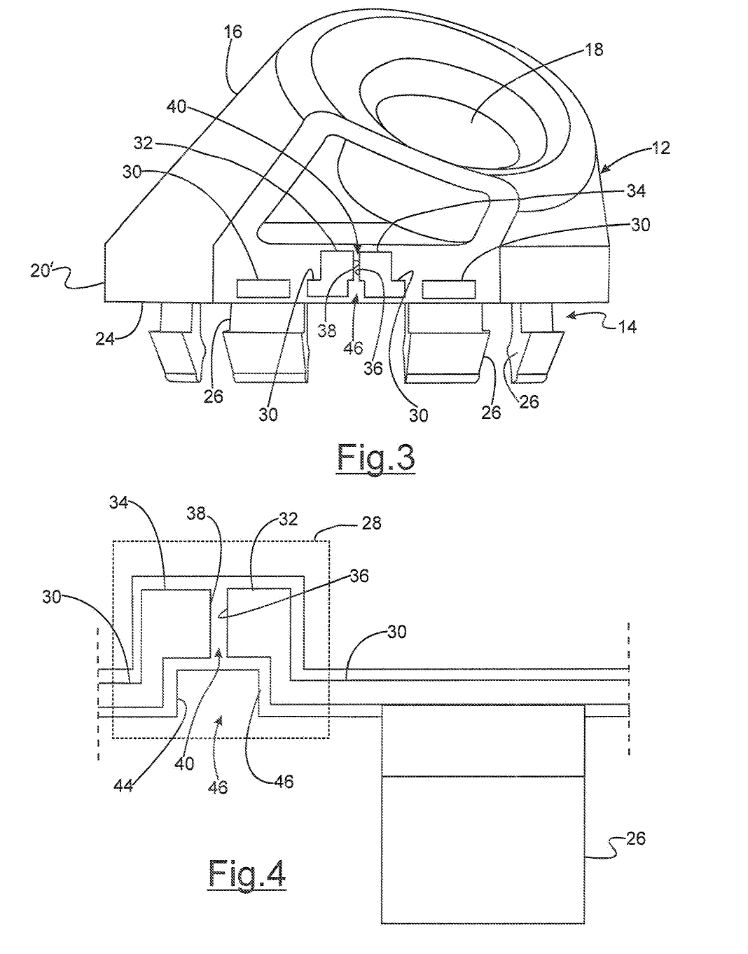

FIG. 4 illustrates a product 10 including a hinge 28 including a first gap 40 and a second gap 46. The first 40 may be completely filled with a compressible or elastomeric material and only a portion of the second may be filled with a compressible or elastomeric material 12. The hinge 28 may be utilized in a variety of products and is not limited to a front of dash seal with a tuned hinge including a clip assembly. In a number of variations of the invention, one or more flexible locking fingers 26 may extend from a bridge deck 30 which may extend between flexible fingers or between adjacent hinges 28.

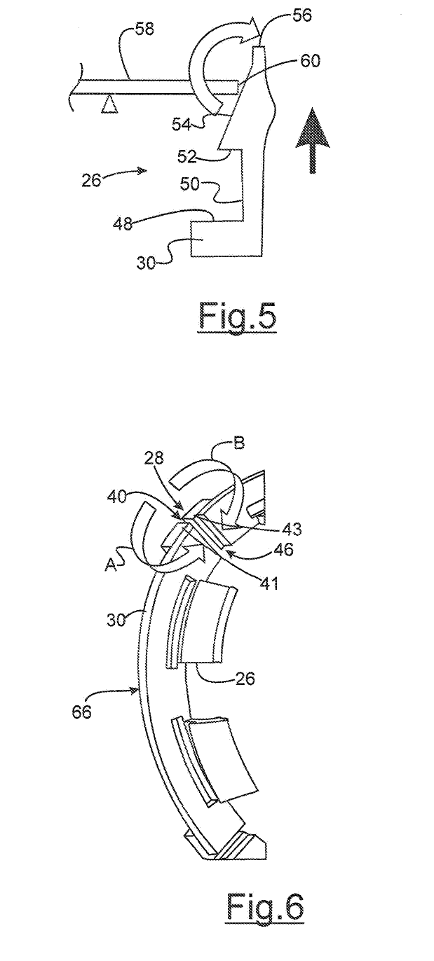

Referring now to FIG. 5, in a number of variations, a flexible locking finger 26 may include a shaft portion 50 extending from an under face 48 of the bridge deck 30. A shoulder 52 may extend outwardly from the shaft portion 50 and may be connected to a ramp surface 58 which extends toward a free end 56 of the flexible locking finger 26. The flexible locking finger 26 may be inserted in an opening 60 and a substrate 58 wherein the flexible locking finger is inserted into the open 60 so that the ramp surface 58 causes the flexible locking finger to flex inwardly until the ramp surface passes the opening 60 and so that the flexible locking finger moves back so that the shoulder 52 locks against the substrate 58 wherein the under face 48 may engage the substrate 58.

Referring now to FIG. 6, the hinge 28 may be constructed and arranged so that lower portions 41, 43 of the first tower 32 and second tower 34, respectively, may be moved toward each other to lower the insertion force required than if the first clip segment 66 and the second clip segment 68 were joined together as a single continuous structure.

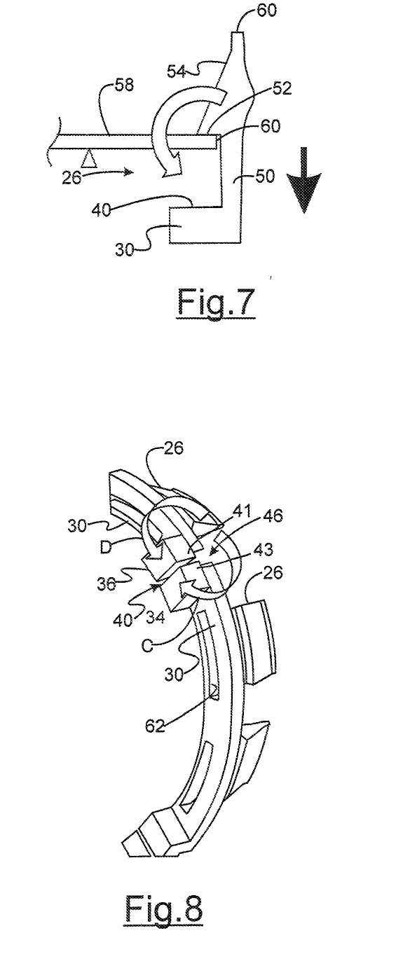

Referring now to FIG. 7, the flexible locking finger 26 may be extracted from the opening 60 in the substrate 58 by pushing the flexible locked finger 26 inward until the ramp surface 54 is inside of the opening 60 while pulling the flexible locking finger 26 in the direction of arrows E.

Referring now to FIG. 8, the first gap 40 may be relatively small and may be constructed and arranged to control (with other components) the stiffness of the product 10. Arrows C and D indicate the location and direction of forces that must be applied to clip assembly 14 to disengage the product 10 from the substrate 58 (shown in FIG. 7).

FIG. 9 illustrates a number of variations of the invention including a product 10 having a collar 16 with a plurality of ribs 62 extending from the collar 16 and which may be connected to the flange 20. The ribs 62 may improve the stiffness of the product 10.

FIG. 10 illustrates a variation of the invention including a clip assembly 14 having a first segment 66, second segment 68, third segment 70, and forth segment 72. Each of the segments 66, 68, 70, 72 may include a single flexible locking finger 26 extending downward from a bridge deck 30. Adjacent segments of the clip assembly 14 may define a hinge 28 constructed and arranged in any one of the variations described herein.

FIG. 11 illustrates a product including a clip assembly 14 being inserted into an opening 60 in a substrate 58 according to a number of variations of the invention. In a number of variations the clip assembly 14 may be constructed with a plurality of hinges 28 and a plurality of flexible locking fingers 26. The deformation of the clip assembly 14 as it is inserted into the opening 60 of the substrate 50 is not severe because the insertion forces are mainly absorbed by the compressible or elastomeric material 12 (not shown in FIG. 11 but are otherwise described and shown herein).

FIG. 12 illustrates a product including a clip assembly 14 bulging outward and holding the clip assembly 14 in position in an opening 60 in a substrate 58 according to a number of variations of the invention.

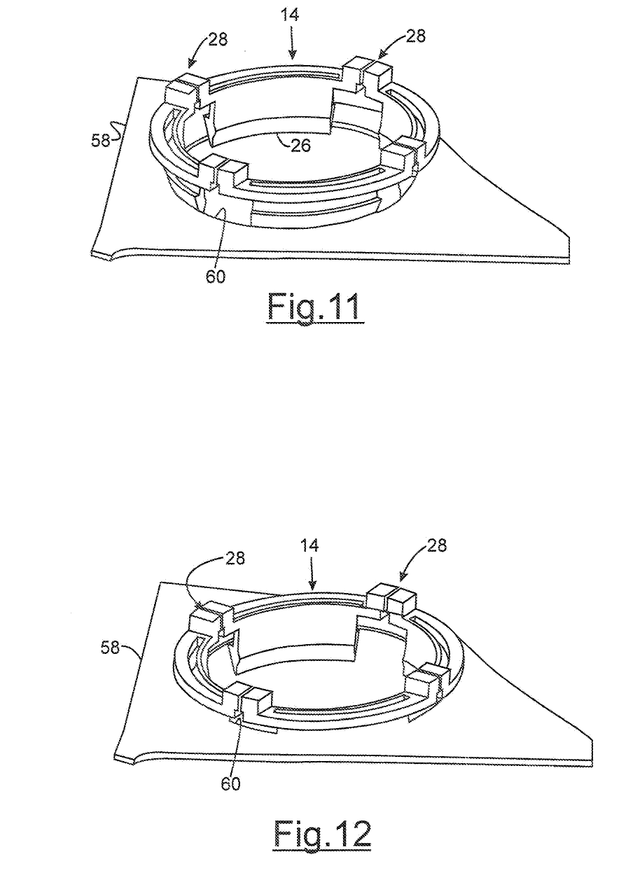

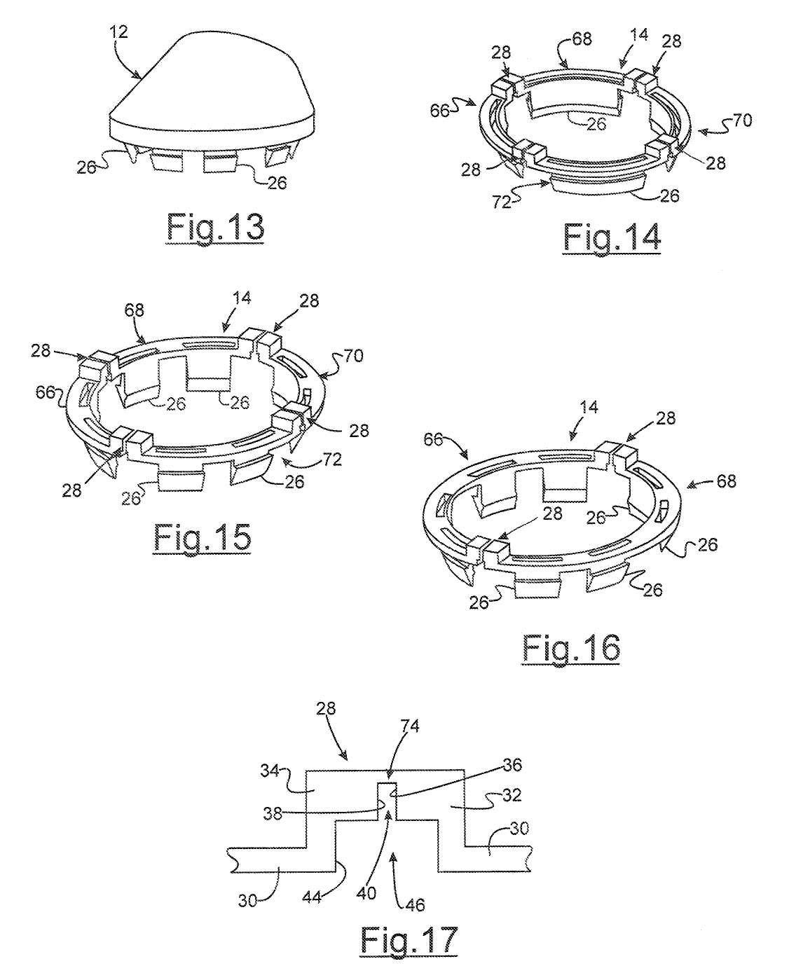

FIG. 13 illustrates a product 10 including a tuned hinge clip assembly 14 with a compressible or elastomeric over mold 12 and a plurality of flexible locking fingers 26 extending from the compressible or elastomeric over mold 12 according to a number of variations of the invention.

FIG. 14 illustrates a product including a clip assembly 14 having four segments 66, 68, 70, 72 and four hinges 28 defined by adjacent portions of the segments. Each segment 66, 68, 70, 72 may have a single flexible finger 28 according to a number of variations of the invention.

FIG. 15 illustrates a product including a dip assembly 14 having four segments 66, 68, 70, 72 and four hinges 28 defined by adjacent portions of the segments. Each segment 66, 68, 70, 72 may have two flexible locking fingers 26 extending from a bridge deck 30 according to a number of variations of the invention.

FIG. 16 illustrates a product including a clip assembly 14 having two segments 66, 68, with two hinges 28 defined by adjacent portions of the segments. Each segment including four flexible locking fingers 26 according to a number of variations of the invention.

FIG. 17 illustrates a product 10 including a tuned hinge 28 having a bridge 74 connecting together adjacent segments according to a number of variations of the invention. The bridge 74 may be helpful in the clip manufacture and handling of the clip assembly 14 as a single piece. The bridge 74 may also facilitate easier insertion and alignment of the clip assembly 14 in a mold for forming the over mold portion 12 over at least a portion of the dip assembly 14. In a number of other variations, the bridge 74 may be a separate piece utilized to temporarily hold adjacent clip assembly segments together. Yet in a number of other variations, the bridge 74 may be constructed and arranged to be melted away by the molten material used to make the over mold portion 12 of the product. A first elongated bridge deck 30 may extend from the first tower 32 and another (second) elongated bride deck 30 may extend from the second tower 34.

The compressible or elastomeric material used for the over more portion 12 may include any of a number of suitable materials, including, but not limited to, natural rubber, synthetic rubber (e.g., EDPM rubber), and/or polyurethane foams. The dip assembly 14 may be made from a polymeric material which is not compressible such as, but not limited to, a nylon material. In other variations of the invention the clip assembly 14 may include a metal. Fibers may be added to the clip assembly polymeric material to increase strength.

A number of variations of the invention may include a method including providing a product including front of dash seal including a clip assembly including a hinge which may include two opposed columns or towers defining at least one gap there between, and a compressible or elastomeric material filling at least a portion of the at least one gap, a bridge deck extending from each of the two opposed columns or towers, at least one flexible locking finger extending downward from the bridge deck, an over mold portion secured to the clip assembly, the over mold portion having a through hole formed therein for receiving a shaft of a vehicle steering column, and wherein the hinge has a first shape when no force is being applied thereto; inserting the at least one flexible locking finger into an opening in a vehicle dash board so that the lower portion of each of the two opposed columns or towers moves toward each other during the inserting so that the hinge has a second shape, and so that after inserting the hinge returns to the first shape and so that the at least one flexible locking finger is releasably locked to the dash board.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: a hinge including two opposed columns or towers defining at least one gap there between, and a compressible or elastomeric material filling at least a portion of the at least one gap.

Variation 2 may include a product as set forth in Variation 1 wherein the two opposed columns or towers define a second gap there between.

Variation 3 may include a product as set forth in any of Variations 1-2 wherein the second gap is void of any compressible or elastomeric material received therein.

Variation 4 may include a product as set forth in any of Variations 1-2 further comprising a compressible or elastomeric material partially filling the second gap.

Variation 5 may include a product as set forth in any of Variations 1-2 further comprising a compressible or elastomeric material completely filling the second gap.

Variation 6 may include a product as set forth in any of Variations 1-5 wherein each of the two opposed columns or towers includes a lower portion and wherein the at least one gap is constructed and arranged so that the lower portion of each of the two opposed columns or towers are moveable toward each other.

Variation 7 may include a product as set forth in any of Variations 1-6 wherein each of the two opposed columns or towers includes a lower portion and wherein the at least one gap and the second gap are constructed and arranged so that the lower portion of each of the two opposed columns or towers are moveable toward each other.

Variation 8 may include a product as set forth in any of Variations 1-7 further comprising a bridge deck extending from each of the two opposed columns or towers.

Variation 9 may include a product as set forth in any of Variations 1-8 further comprising at least one flexible locking finger extending downward from the bridge deck.

Variation 10 may include a product as set forth in any of Variations 1-9 including an over mold portion secured to the hinge.

Variation 11 may include a product including a clip assembly including a hinge including two opposed columns or towers defining at least one gap there between, and a compressible or elastomeric material filling at least a portion of the at least one gap, a bridge deck extending from each of the two opposed columns or towers, at least one flexible locking finger extending downward from the bridge deck.

Variation 12 may include a product as set forth in Variation 11 wherein the two opposed columns or towers define a second gap there between.

Variation 13 may include a product as set forth in any of Variations 11-12 wherein the second gap is void of any compressible or elastomeric material received therein.

Variation 14 may include a product as set forth in any of Variations 11-12 further comprising a compressible or elastomeric material partially filling the second gap.

Variation 15 may include a product as set forth in any of Variations 11-12 further comprising a compressible or elastomeric material completely filling the second gap.

Variation 16 may include a product as set forth in any of Variations 11-15 wherein each of the two opposed columns or towers includes a lower portion and wherein the at least one gap is constructed and arranged so that the lower portion of each of the two opposed columns or towers are moveable toward each other.

Variation 17 may include a product as set forth in any of Variations 11-16 wherein each of the two opposed columns or towers includes a lower portion and wherein the at least one gap and the second gap are constructed and arranged so that the lower portion of each of the two opposed columns or towers are moveable toward each other.

Variation 18 may include a product as set forth in any of Variations 11-17 further comprising an over mold portion secured to the clip assembly, the over mold portion having a through hole formed therein for receiving a shaft of a vehicle steering column.

Variation 19 may include a method comprising: providing a product including front of dash seal including a dip assembly including a hinge including two opposed columns or towers defining at least one gap there between, and a compressible or elastomeric material filling at least a portion of the at least one gap, a bridge deck extending from each of the two opposed columns or towers, at least one flexible locking finger extending downward from the bridge deck, an over mold portion secured to the clip assembly, the over mold portion having a through hole formed therein for receiving a shaft of a vehicle steering column, and wherein the hinge has a first shape when no force is being applied thereto; inserting the at least one flexible locking finger into an opening in a vehicle dash board so that the lower portion of each of the two opposed columns or towers move toward each other during the inserting so that the hinge has a second shape, and so that after inserting the hinge returns to the first shape and so that the at least one flexible locking finger is releasably locked to the dash board.

Variation 20 may include a method as set forth in Variation 19 wherein the two opposed columns or towers define a second gap there between.

The above description of select examples of the invention is merely exemplary in nature and, thus, variations or variants thereof are not to be regarded as a departure from the spirit and scope of the invention.

1. A product comprising:
a hinge including two opposed columns or towers defining at least one gap there between, and a compressible or elastomeric material filling at least a portion of the at least one gap.

2. A product as set forth in claim 1 wherein the two opposed columns or towers define a second gap there between.

3. A product as set forth in claim 2 wherein the second gap is void of any compressible or elastomeric material received therein.

4. A product as set forth in claim 2 further comprising a compressible or elastomeric material partially filling the second gap.

5. A product as set forth in claim 2 further comprising a compressible or elastomeric material completely filling the second gap.

6. A product as set forth in claim 1 wherein each of the two opposed columns or towers includes a lower portion and wherein the at least one gap is constructed and arranged so that the lower portion of each of the two opposed columns or towers are moveable toward each other.

7. A product as set forth in claim 2 wherein each of the two opposed columns or towers includes a lower portion and wherein the at least one gap and the second gap are constructed and arranged so that the lower portion of each of the two opposed columns or towers are moveable toward each other.

8. A product as set forth in claim 1 further comprising a bridge deck extending from each of the two opposed columns or towers.

9. A product as set forth in claim 8 further comprising at least one flexible locking finger extending downward from the bridge deck.

10. A product as set forth in claim 2 including an over mold portion secured to the hinge.

11. A product comprising:
a clip assembly including a hinge including two opposed columns or towers defining at least one gap there between, and a compressible or elastomeric material filling at least a portion of the at least one gap, a bridge deck extending from each of the two opposed columns or towers, at least one flexible locking finger extending downward from the bridge deck.

12. A product as set forth in claim 11 wherein the two opposed columns or towers define a second gap there between.

13. A product as set forth in claim 12 wherein the second gap is void of any compressible or elastomeric material received therein.

14. A product as set forth in claim 12 further comprising a compressible or elastomeric material partially filling the second gap.

15. A product as set forth in claim 12 further comprising a compressible or elastomeric material completely filling the second gap.

16. A product as set forth in claim 11 wherein each of the two opposed columns or towers includes a lower portion and wherein the at least one gap is constructed and arranged so that the lower portion of each of the two opposed columns or towers are moveable toward each other.

17. A product as set forth in claim 12 wherein each of the two opposed columns or towers includes a lower portion and wherein the at least one gap and the second gap are constructed and arranged so that the lower portion of each of the two opposed columns or towers are moveable toward each other.

18. A product as set forth in claim 12 further comprising an over mold portion secured to the clip assembly, the over mold portion having a through hole formed therein for receiving a shaft of a vehicle steering column.

19. A method comprising:
providing a product including front of dash seal including a clip assembly including a hinge including two opposed columns or towers defining at least one gap there between, and a compressible or elastomeric material filing at least a portion of the at least one gap, a bridge deck extending from each of the two opposed columns or towers, at least one flexible locking finger extending downward from the bridge deck, an over mold portion secured to the clip assembly, the over mold portion having a through hole formed therein for receiving a shaft of a vehicle steering column, and wherein the hinge has a first shape when no force is being applied thereto;
inserting the at least one flexible locking finger into an opening in a vehicle dash board so that the lower portion of each of the two opposed columns or towers move toward each other during the inserting so that the hinge has a second shape, and so that after inserting the hinge returns to the first shape and so that the at least one flexible locking finger is releasably locked to the dash board.

20. A method as set forth in claim 19 wherein the two opposed columns or towers define a second gap there between.
